(19) United States
(12) Patent Application Publication
(10) Pub. No.: US 2008/0220404 A1
(43) Pub. Date: Sep. 11, 2008

(54) Articulator

(75) Inventor: Horst Woidschutzke, Wangen (DE)

Correspondence Address: Pandiscio & Pandiscio, 470 Totten Pond Road, Waltham, MA, 02451, US

(73) Assignee: Franz Sachs GmbH & Co. KG

(21) Appl. No.: 12/074,513

(22) Filed: Mar. 4, 2008

(30) Foreign Application Priority Data
Mar. 9, 2007 (EP) 07004840.0

(51) Int. Cl. G09B 23/28

(52) U.S. Cl. 434/263

(57) ABSTRACT

In an articulator (1) by means of which demonstration movements of a lower jaw model (8) can be undertaken and comprising a two-piece carrier frame (2) with an upper jaw model (7) attached to its locationally fixed top part (3) and the lower jaw model (8) attached to its bottom part (4) that can be pivoted to a limited extent about a horizontally running axis (shaft 5), the lower jaw model (8) is supported on the bottom part (4) of the carrier frame (2) by means of an adapter (11) and the adapter (11) is mounted in the bottom part (4) in a rotating arrangement. This embodiment makes it possible for different jaw models to be attached to the top part (3) and the bottom part without difficulty, without the need to undertake machining operations or to have technical knowledge. In addition, the two jaw models (7 and 8) can be aligned with one another without problems.

The present invention relates to an articulator by means of which demonstration movements of a lower jaw model can be undertaken, comprising a two-part carrier frame attached to a plate or a stand, on the locationally fixed top part of which is attached an upper jaw model and on the bottom part of which the lower jaw model is attached, this bottom part having the ability to pivot to a limited extent about a horizontal axis in relation to the top part.

Demonstration articulators that permit simple functional movements of the lower jaw are available from the company frasaco GmbH of Oberhofer Strasse 18, 88069 Tettnang under the designation “AG-3 DA” and have proven effective in practice. These jaw models are firmly screwed onto the top part and the bottom part of the carrier frame and each part has to be matched to this carrier frame. In the event that a jaw model suffers damage, it is not a simple matter to replace it because the plastic jaw models and/or the carrier frame must have their contact surfaces machined in order to match them with their counterpart. Occasionally, this procedure is very time consuming and cannot be achieved by a user of the articulator, so that in many cases no repair is attempted. Furthermore, it is disadvantageous that there is no possibility provided of adjusting the jaw models in relation to one another and that no different jaw models can be used. Therefore, the range of applications of the demonstration articulator is restricted.

It is therefore the task of the present invention to design an articulator of the aforementioned kind in such a way that not only different jaw models can be attached to the top part and/or bottom part of the carrier frame but that they can above all be replaced easily and within a short period of time without the need either for machining operations or technical knowledge. Furthermore, the present invention is intended to allow both jaw models to be aligned with one another without difficulty thereby permitting a wide variety of applications with straightforward handling.

In accordance with the present invention, this is achieved in an articulator of the aforementioned type in that the lower jaw model is supported on the bottom part of the carrier frame by means of an adapter and that the adapter is mounted in the bottom part in a rotating arrangement.

It is advantageous in this case for the bottom part of the carrier frame to consist of two cheeks arranged with a lateral distance in between them by means of cross struts, with the top part inserted in between the cheeks, and for the two cheeks of the bottom part to be mounted in a pivoting arrangement in the end area facing away from the lower jaw model, on a shaft that passes through the top part.

For this purpose, both the cheeks of the bottom part should each have an accommodation opening in the end area facing away from the lower jaw model for accommodating the shaft that passes through the adapter, with the possibility for the accommodation openings of the two cheeks to be configured as cylindrical holes, as slots that are either open at one end or closed, or an open cam in order to increase the adjustment range.

The adapter should consist of a carrier plate and two legs each projecting from the end areas of the carrier plate with a gap in between them, between which the cheeks of the bottom part of the carrier frame can be inserted.

The top part of the carrier frame can, in a simple embodiment, also consist of a rectangular carrier frame with its end area facing the upper jaw model configured as an adapter.

To facilitate exchanging parts, the carrier plates of the adapter and/or the adapter of the top part of the carrier frame should each be provided with holders, e.g. in the form of dovetail-like attachments, for holding the lower jaw model and/or the upper jaw model, with press fasteners or the like, in which case the adjustment range of each of the holders should be restricted by a stop allocated to the end positions of the upper and/or lower jaw models.

The upper jaw model and/or the lower jaw model can be attached to an angular bar or inserted in a shell that are supported on the top part, on its adapter or on an attachment connected to this adapter, or to the adapter of the bottom part of the carrier frame, or the upper jaw model and/or the lower jaw model can be directly attached to the upper jaw or the adapter of the bottom part.

If an articulator is configured in accordance with the present invention, it is quickly and easily possible to replace both upper jaw models and lower jaw models in case of damage without the need to machine the carrier frame and/or the jaw models. This is because the rotating mounting of the adapter holding the lower jaw model makes it possible to align the lower jaw model with the upper jaw model without difficulties and therefore replacement is possible without any problems.

Furthermore, it is advantageous that even differently configured jaw models can be attached to the top and/or bottom part of the carrier frame subsequently. This is because the rotating mounting in connection with the ability to pivot the bottom part makes it possible to compensate for different heights of teeth and models. Also, the jaw models can easily be removed from the components that carry them or can be clipped onto these components, therefore the articulator in accordance with the present invention can be used for a long period of time whilst also providing ease of handling.

The drawing shows a sample embodiment of a demonstration articulator configured in accordance with the present invention, the details of which are explained below. In the drawing,

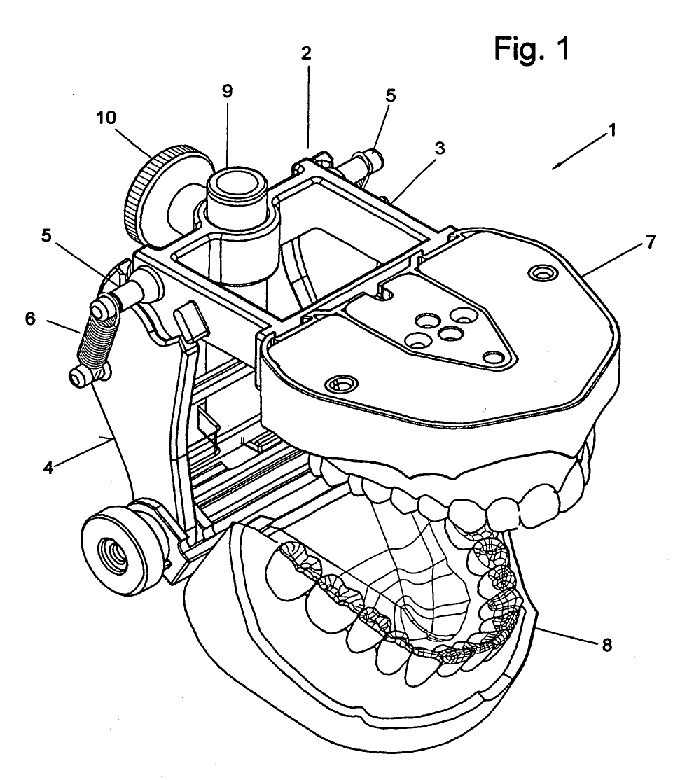

FIG. 1 shows the articulator consisting of a two-part carrier frame with jaw models attached to it, in a perspective view,

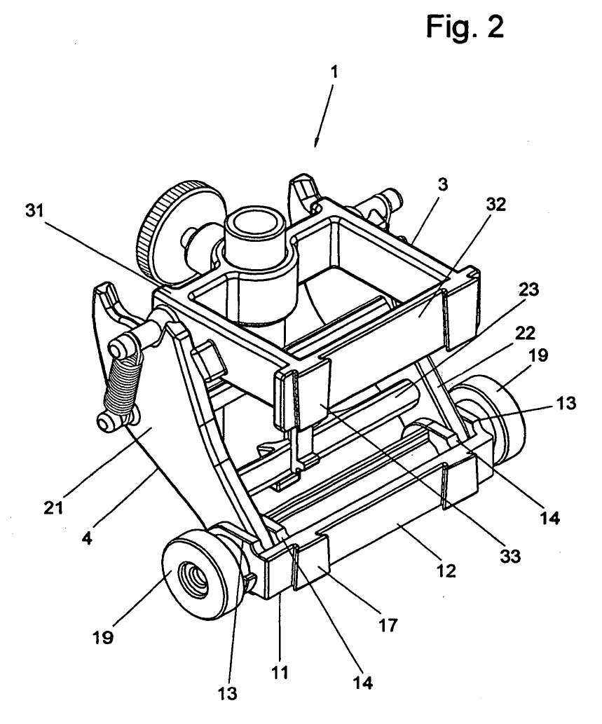

FIG. 2 shows the articulator in accordance with FIG. 1 without the two jaw models,

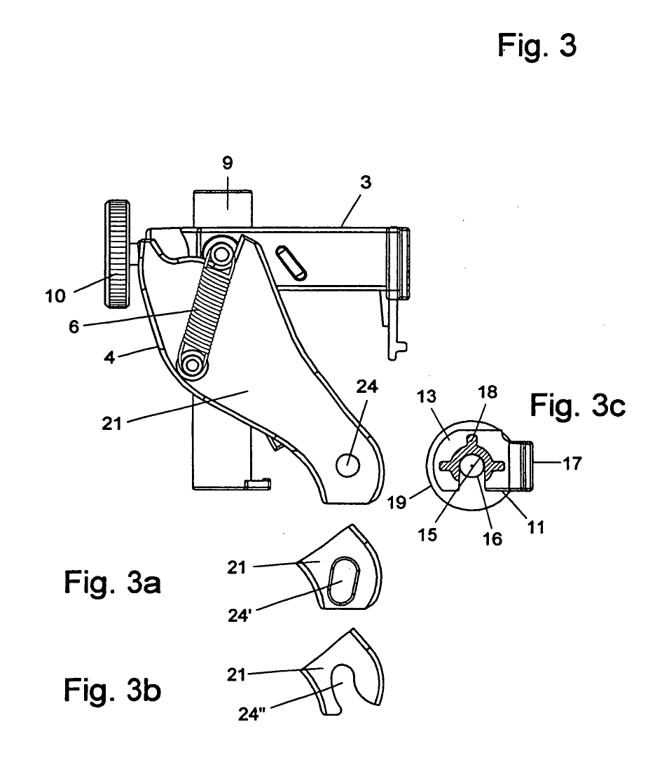

FIG. 3 shows the carrier frame of the articulator in accordance with FIG. 1, in a side view,

FIGS. 3a and 3b each show a section from FIG. 3 with differently configured accommodation openings,

FIG. 3c shows the adapter using in the articulator in accordance with FIG. 1, in a section view,

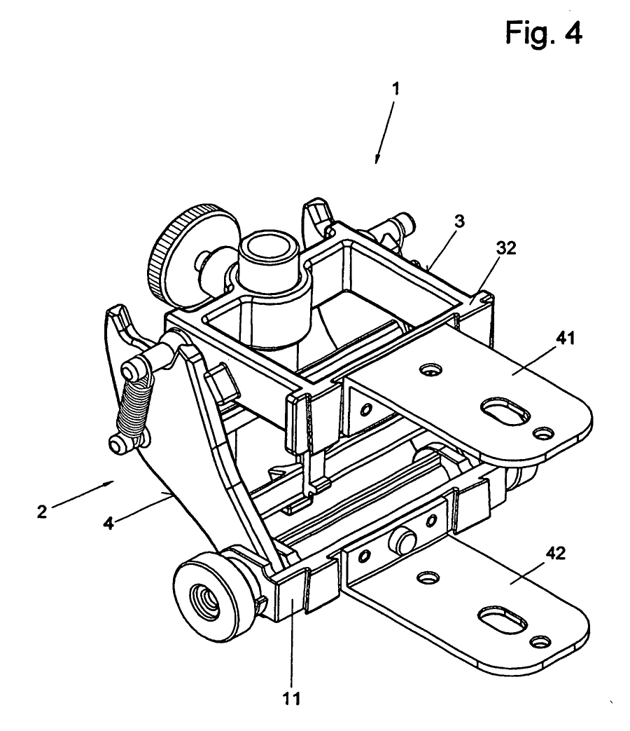

FIG. 4 shows the articulator in accordance with FIG. 2 with angular bars screwed on in order to hold the jaw model,

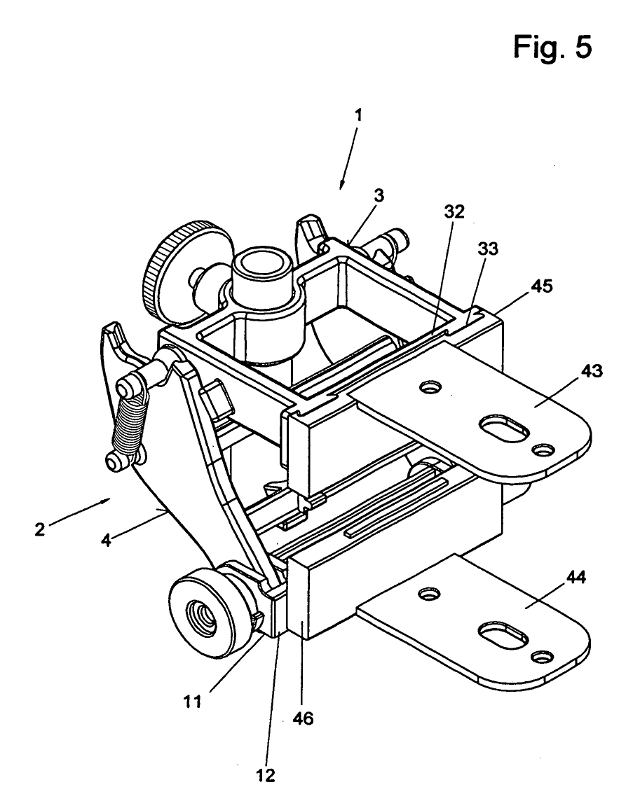

FIG. 5 shows the articulator in accordance with FIG. 4 in a variant embodiment,

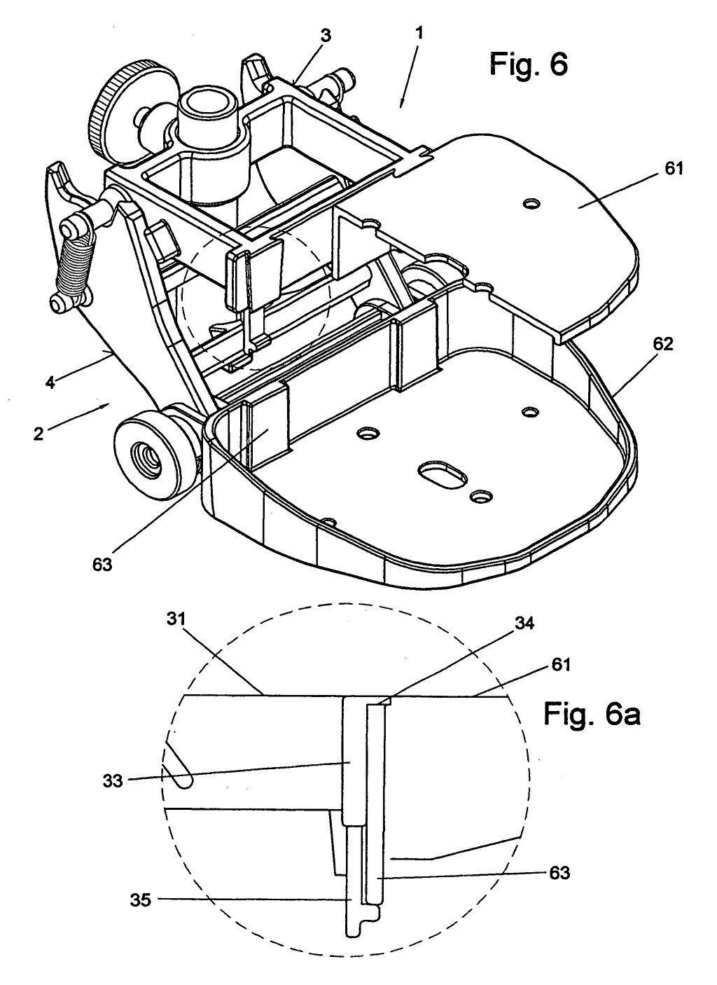

FIG. 6 shows the articulator in accordance with FIG. 2 with shells for holding the jaw models and

FIG. 6a shows a magnified section of FIG. 6.

The articulator shown in FIGS. 1 to 6 and identified with 1 in each case is used for enabling demonstration movements to be performed on a lower jaw model 8, and principally consists of a two-part carrier frame 2 on which are held an upper jaw model 7 on a top part 3 and the lower jaw model 8 on a bottom part 4 either directly or by means of adapters. The bottom part 4 of the carrier frame 2 can be swiveled about an axis formed by pins 5 inserted in the top part 3 of the carrier frame 2, with this swiveling movement taking place against the force of two return springs 6. By means of a sleeve 9 inserted in the top part 3, it is possible to connect the articulator 1 to a stand and lock it on the stand by means of a setscrew 10.

In order to allow the lower jaw model 8 to be aligned when fitting out the articulator 1 or, if necessary, after replacing the lower jaw model 8, it can easily be aligned with the upper jaw model 7 attached in a fixed location on the top part 3 of the carrier frame 2 because the lower jaw model 8 is able to rotate on the bottom part 4 by means of an adapter 11. For this purpose, the adapter 11 consists of a carrier plate 12 and webs 13 and 14 projecting in pairs from the end areas of the carrier plate 12 and spaced apart in parallel, between which pass cheeks 21 or 22 connected together by cross-struts 23 and serve to form the bottom piece 3. A passage hole 15 is worked into the adapter 11 and the cheeks 21 and 22 are provided with accommodation openings 24, 24′ and 24″ in which a shaft 16 is mounted in a rotating arrangement. The adapter 11 is locked between the cheeks 21 and 22 by nuts 19 screwed onto the ends of the shaft 16.

In order to allow the connection of the lower jaw model 4 to be released, the carrier plate 12 is provided with attachments 17 configured in the form of dovetail-shaped guides. In addition, as can be seen in particular in FIG. 3c, several reinforcement webs 18 are formed on the adapter 11. Also, in order to increase the adjustment range of the lower jaw model 4, the accommodation openings 24 worked into the cheeks 21 and 22 have different embodiments. In accordance with FIG. 3, the accommodation openings 24 are configured as cylindrical holes, in accordance with FIGS. 3a and 3b, however, they are configured as a slot 24′ or an open cam 24″, with the result that even a slight axial offset of the lower jaw model 4 can be compensated.

The top part 3 of the carrier frame 2 is, as can be seen in FIG. 2, for example, configured as a rectangular carrier frame 31 with its side facing the upper jaw model 7 configured as an adapter 32 on which attachments 33 configured as dovetail-shaped guides are also formed. Therefore, as is shown in FIG. 1, the upper jaw model 7 and the lower jaw model 8 can be directly connected to the attachments 17 or 33 of the adapter 11 or the adapter 32.

In accordance with FIG. 4, a bar 41 or 42 can be screwed onto the adapter 32 or the adapter 11 and, in turn, the upper jaw model 7 or the lower jaw model 8 can be attached to the bar 41 or 42. In accordance with FIG. 5, bars 43 or 44 can also be attached to attachments 45 or 46 that are clipped onto the adapter 32 or the adapter 11.

The upper jaw model 7 and the lower jaw model 8 can also, as shown in FIG. 6, be inserted in shells 61 or 62 that are in a releasable connected with the adapter 32 of the top part 3 or the adapter 11. The shells 61 and 62 are provided with corresponding seats 63 adapted to the attachments 17 or 33.

The attachments 17 and 33 are, as shown in a magnified view in FIG. 6a, each equipped with a stop 34 in order to limit the adjustment travel of the components engaging in them, for example the seats 63, in a vertical direction. Also, so that the shell 61 cannot slide off, as is shown in FIG. 6a, there is a springy web 35 formed on the attachment 33 which reaches behind the seat 63 of the of the shell and/or the model 61.

Given all the illustrated configuration versions of the articulator 1, it is possible to align the lower jaw model 8 supported on the bottom part 4 of the carrier frame 2 with the upper jaw model 7 attached to the top part 3 that is in a fixed location, with this alignment being possible both towards each other in the same plane and, to a restricted extent, in an axial direction. As a result, exercises relating to preventative, preservative and prosthetic dentistry can easily be carried out with consideration for functional occlusion relationships.

1. An articulator (1) by means of which demonstration movements of a lower jaw model (8) can be undertaken, the articulator comprising a two-part carrier frame (2) attached to a stand, a top part (3) of which is attached an upper jaw model (7) and a bottom part (4) of which is attached to a lower jaw model (8), the bottom part (4) being adapted to pivot about a horizontal axis (5) in relation to the top part (3), wherein the lower jaw model (8) is supported on the bottom part (4) of the carrier frame by means of a first adapter (11), and wherein the first adapter is rotatable mounted in the bottom part.

2. The articulator in accordance with claim 1, wherein the bottom part (4) of the carrier frame (2) comprises two cheeks (21, 22) arranged with a lateral distance between them defined by struts, the top part (3) being disposed between the cheeks (21, 22).

3. The articulator in accordance with claim 2, wherein the two cheeks (21, 22) of the bottom part (4) are mounted in a pivoting arrangement on a shaft (5) that passes through the top part (3).

4. The articulator in accordance with claim 2, wherein the cheeks (21, 22) of the bottom part (4) each have an accommodation opening (24, 24′, 24″) in an end area for accommodating a shaft (16) that passes through the first adapter (11).

5. The articulator in accordance with claim 4, wherein the accommodation openings of the two cheeks (21, 22) are configured in a selected one of as cylindrical holes (24), slots (24′), and open cams (24″).

6. The articulator in accordance with claim 2, wherein the first adapter (11) comprises a carrier plate (12) and two legs (13, 14) each projecting from end areas of the carrier plate (12) with a gap, between which the cheeks (21, 22) of the bottom part of the carrier frame (2) are insertable.

7. The articulator in accordance with claim 1, wherein the top part (3) of the carrier frame (2) comprises a rectangular carrier frame (31) having an end area facing the upper jaw model (7) and configured as a second adapter (32).

8. The articulator in accordance with claim 6, wherein the carrier plate (12) of the first adapter (11) and the second adapter (32) are each provided with vertically running holders, in the form of dovetail-like portions (17 or 33), for holding the lower jaw model (8) and the upper jaw model (7).

9. The articulator in accordance with claim 8, wherein an adjustment range of each of the holders is restricted by a stop (34, 35) allocated to the end positions of the upper and lower jaw models.

10. The articulator in accordance with claim 7, wherein the upper jaw model (7) and the lower jaw model (8) are selectively attached to an angular bar (41, 42), or inserted in a shell (61, 62), supported on the top part (3), on the second adapter (32), or on an attachment (45, 46) connected to the second adapter (32), or to the first adapter (11) of the bottom part (4) of the carrier frame (2), or are directly attached to the upper jaw (3) or the first adapter (11) of the bottom part (4).
